(19) United States
(12) Patent Application Publication
(10) Pub. No.: US 2018/0180256 A1
(43) Pub. Date: Jun. 28, 2018

(54) ELECTROWETTING CELLULAR ARRAY AND LUMINAIRE INCORPORATING THE ARRAY

(71) Applicant: ABL IP HOLDING LLC, Conyers, GA (US)

(72) Inventors: An Mao, Herndon, VA (US); Guan-Bo Lin, Reston, VA (US); Ravi Kumar Komanduri, Ashburn, VA (US); Rashmi Kumar Raj, Herndon, VA (US); David P. Ramer, Reston, VA (US)

(21) Appl. No.: 15/389,829

(22) Filed: Dec. 23, 2016

(51) Int. Cl. F21V 14/00; G02B 26/00; F21S 8/08; G02F 1/29; F21V 23/04; F21V 33/00

(52) U.S. Cl. CPC F21V 14/003; G02B 26/005; F21S 8/086; F21W 2111/02; F21V 23/0442; F21V 33/00; G02F 2203/24; G02F 1/29

(57) ABSTRACT

A cellular electrowetting array, e.g. for a luminaire, includes a liquid container having opposing transparent windows. The container contains conductive and non-conductive liquids. A grid wall extends from one of the windows at least partially across the interior volume of the container toward the opposite window. The grid wall divides the interior volume into cellular fluidic optics, each containing some conductive liquid and some non-conductive liquid. The individual cells may be square, although other shapes may be used. A first electrode electrically connects to the grid wall; and a second electrode contacts the conductive liquid. System examples combine such an electrowetting array with a positive or negative lens array, e.g. optically coupled to one of the windows of the array. The electrowetting array or a system combining that array with another lens array may be utilized in a luminaire, e.g. to provide a tunable distribution of the general illumination output.

### TECHNICAL FIELD

The disclosed subject matter relates to improvements to electrowetting lens arrays, e.g. to adapt such arrays for use in lighting devices/luminaires.

### BACKGROUND

Electrowetting lenses are conventionally used in the camera industry. These lenses tend to be very small (several millimeters) and operate in a small tunable range (small range of output light angle). The thickness of the lenses are also typically less than half the lens size.

As a result, these lenses are not suitable for larger scale lighting solutions. For example, conventional electrowetting lenses (due to their small size and small tunable range) are not easily adaptable to create a tunable distribution in a luminaire for installation in a residential or commercial setting.

There have been proposals to develop arrays of electrowetting lens cells. Such arrays, however, have used a number of the small size/small tunable range cells. Although such an array can steer light from a larger overall input area the cells of some prior types of such an array often offer only a relatively small angular tunable range of light output. Arrays with cells have been described using 1-chloronaphthalene, a very high refractive index liquid. These cells have a large tunable range. Nevertheless, the range and/or scalability to support luminaire applications can still be improved.

Hence, there is further room for improvement in arrays of electrowetting lenses, e.g. to achieve better scalability and/or to better adapt the lens arrays for use in a configurable general illumination type luminaire while offering a wider tunable angular range of light output as may be desirable for such an application.

### SUMMARY

The examples discussed herein improve over prior electrowetting lens arrays and address one or more issues with prior implementations of electrowetting lens arrays. Such a cellular electrowetting lens array also may be combined into a lens array system, for example, combining the cellular electrowetting array with an associated positive or negative lens array. The electrowetting lens array or a system combining such an electrowetting array with another lens array may be utilized in a luminaire, e.g. to provide a tunable light output distribution of the luminaire for an artificial lighting application.

In an example, a cellular electrowetting array includes a liquid container enclosing an interior volume and having first and second windows formed of transparent material located to allow passage of light through the liquid container, including through the interior volume. The array also includes two liquids that are immiscible with respect to each other, which together fill the interior volume of the liquid container. One liquid is relatively insulating, and the other liquid is relatively conductive. This example also includes a grid wall inside the interior volume of the liquid container that extends from one of the windows at least partially across the interior volume toward the other window. The grid wall divides the interior volume of the liquid container into individual electrowetting lens cells each containing some of the first liquid and some of the second liquid. A first electrode is electrically connected to the grid wall; and a second electrode is configured to contact the conductive liquid. The electrodes are configured to receive a voltage for imparting a force to at least one of the liquids that changes the shape of the insulating liquid within each cell of the electrowetting lens array thereby modifying the focal point of light passing through the windows and the liquids in the cells of the electrowetting lens array.

The system examples combine such a cellular electrowetting array with a positive or negative lens array, e.g. a lens array optically coupled to one of the windows of the electrowetting array.

In an example with a positive lens array, the positive lens array is mounted in proximity to one of the windows of the cellular electrowetting lens array. The positive lens array modifies a focal point of light being transmitted through the one window.

In an example of a negative lens system, the negative lens array mounted in proximity to one of the windows of the cellular electrowetting lens array. The negative lens array modifies the focal point of light being transmitted through the windows and cells of the electrowetting lens array.

In any of these system examples, the individual lenses of the positive lens array or the negative lens array may be aligned with individual cells of the electrowetting lens array.

In another example, a cellular electrowetting array has a first window formed of transparent material, a first electrode attached with one or more inward facing surfaces encompassing at least a portion of an interior volume. A second electrode is mounted so as to be electrically isolated from the first electrode. The array also includes a second window formed of transparent material. The windows and electrodes together form elements of a liquid container containing the interior volume. The array includes two liquids that are immiscible with respect to each other, which together fill the interior volume of the liquid container. The first liquid is relatively insulating, and the second liquid is relatively conductive. Also, one of the liquids has a higher index of refraction than the other of liquid. Also included is a grid wall inside the interior volume of the liquid container and extending from one of the windows at least partially across the interior volume toward the other of the windows. The grid wall is located so as to divide the interior volume of the liquid container into individual electrowetting lens cells of the array. Each electrowetting lens cell contains some of the first liquid and some of the second liquid. The electrodes are configured to receive a voltage imparting a force to at least one of the liquids that changes the shape of the insulating liquid within each cell of the array thereby modifying a focal point of light passing through the windows and the liquids in the cells of the array.

Any of the cellular electrowetting array examples or the system examples may be coupled with a suitable source of light for artificial illumination in a manner coupling light from the source as part of a residential or commercial light luminaire.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1A shows a view of a cellular electrowetting lens array operating in a negative state.

FIG. 1B shows a view of the cellular electrowetting lens array of FIG. 1A but when operating in a positive state.

FIG. 1C shows a view of an example of an integral electrode and grid structure, having an outer rim electrode and a grid wall that separates the volume of the electrowetting optic into cells each of a substantially square shape.

FIG. 1D shows a view of a cellular electrowetting lens array with electrically isolated electrodes in each cell to perform beam steering of the light source.

FIG. 2A shows a view of a positive lens array system including both a cellular electrowetting lens array and an associated positive lens array.

FIG. 2B shows a view of a negative lens array system including both a cellular electrowetting lens array and an associated negative lens array.

FIG. 3A shows a view of light passing through the positive electrowetting lens array system in FIG. 2A.

FIG. 3B shows a view of light passing through the negative an electrowetting lens array system in FIG. 2B.

FIG. 4A shows a data plot of focus versus applied voltage for the electrowetting lens array in FIG. 1A.

FIG. 4B shows a data plot of output light angle versus applied voltage for the electrowetting lens array in FIG. 1A.

FIG. 5A shows a data plot of focus versus applied voltage for the positive electrowetting lens array system in FIG. 2A.

FIG. 5B shows a data plot of output light angle versus applied voltage for the positive electrowetting lens array system in FIG. 2A.

FIG. 6 shows a view of a light fixture that includes a positive electrowetting lens array system as well as a control system (shown in high level block diagram form) for controlling the positive electrowetting lens array system of FIG. 2A to produce a specified beam of light.

FIG. 7 shows a view of a luminaire in the form of a commercial light fixture (e.g. a street lamp).

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Electrowetting is a fluidic phenomenon that enables changing of the configuration of a contained fluid system in response to an applied voltage. In general, application of an electric field seemingly modifies the wetting properties of a surface (e.g. the ability of liquid to maintain physical contact with a hydrophobic surface) in the fluid system. Assuming a two fluid system, where one fluid is relatively conductive, and the other is relatively insulating; when a liquid is in contact with a surface and that surface becomes charged, the electric field tends to pull the mass of an electrically conductive liquid down towards the surface. As the conductive liquid changes shape due to this force, the non-conductive liquid also changes shape. On a micro scale, the contact angle is unaffected. On a macro scale it seems that the wetting properties have changed. This phenomenon enables controlled changes to the overall distribution and shape of the liquids with respect to the surface in response to changes of the voltage(s) applied to change the electric field.

Examples of electrowetting optics described in detail herein and shown in several of the drawings use two immiscible liquids having different electrical properties. In at least some examples, the two liquids have different indices of refraction. One liquid may be conductive. The other liquid, typically the liquid adjacent to the hydrophobic surface, may be non-conductive. The conductive liquid may be a transparent liquid, but the other liquid may be substantially transparent or transmissive. Where both liquids are transparent or transmissive, the non-conductive liquid may exhibit a higher index of refraction than the conductive liquid. However, this is not necessary. In some examples, the non-conductive liquid may exhibit a lower index of refraction than the conductive liquid. In such a transmissive optic example, changing the applied electric field changes the shape of the liquid interface surface between the two liquids and thus the refraction of the light passing through the interface surface, for example, so that the electrowetting optics operates as a variable shape lens. Depending on the application for the electrowetting optic, the light may enter the liquid system to pass first through either one or the other of the two liquids.

Electrowetting technology has been used to produce optical electrowetting lenses for use in cameras or the like. By applying voltage to an electrowetting lens, the shape of the one or more internal liquids within the lens structure changes thereby selectively controlling focus and output angle of any light that is transmitted through the liquids of the lens, e.g. light received from a field of view for input to an image sensor (camera application).

Examples of electrowetting optics, particularly multi-cell arrays, are described herein which also are suitable to lighting applications, e.g. to controllably shape and/or steer light output obtained from a light generating source. For such applications, by applying voltage to an electrowetting lens, the shape of the one or more of the internal liquids within the lens structure changes thereby selectively controlling focus and output angle of any light that is transmitted through the liquids of the lens. In the lighting example, the change of state in the fluid system within the cellular array changes the focus and output angle of light received from a source for tunable output light distribution over a field of intended illumination.

For such lighting applications, the cellular electrowetting array and any associated positive or negative lens array are combined with a suitable light source in or to form a luminaire for an artificial illumination application.

The term “luminaire,” as used herein, is intended to encompass essentially any type of device that processes energy to generate or supply artificial light, for example, for general illumination of a space intended for use of occupancy or observation, typically by a living organism that can take advantage of or be affected in some desired manner by the light emitted from the device. However, a luminaire may provide light for use by automated equipment, such as sensors/monitors, robots, etc. that may occupy or observe the illuminated space, instead of or in addition to light provided for an organism. However, it is also possible that one or more luminaires in or on a particular premises have other lighting purposes, such as signage for an entrance or to indicate an exit. In most examples, the luminaire(s) illuminate a space or area of a premises to a level useful for a human in or passing through the space, e.g. general illumination of a room or corridor in a building or of an outdoor space such as a street, sidewalk, parking lot or performance venue. The actual source of illumination light in or supplying the light for a luminaire may be any type of artificial light emitting device, several examples of which are included in the discussions below.

Terms such as “artificial lighting,” as used herein, are intended to encompass essentially any type of lighting that a device produces light by processing of electrical power to generate the light. An artificial lighting device, for example, may take the form of a lamp, light fixture, or other luminaire that incorporates a light source, where the light source by itself contains no intelligence or communication capability, such as one or more LEDs or the like, or a lamp (e.g. “regular light bulbs”) of any suitable type. The illumination light output of an artificial illumination type luminaire, for example, may have an intensity and/or other characteristic(s) that satisfy an industry acceptable performance standard for a general lighting application.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

Light output from the luminaire may carry information, such as a code (e.g. to identify the luminaire or its location) or downstream transmission of communication signaling and/or user data. The light based data transmission may involve modulation or otherwise adjusting parameters (e.g. intensity, color characteristic or distribution) of the illumination light output from the device.

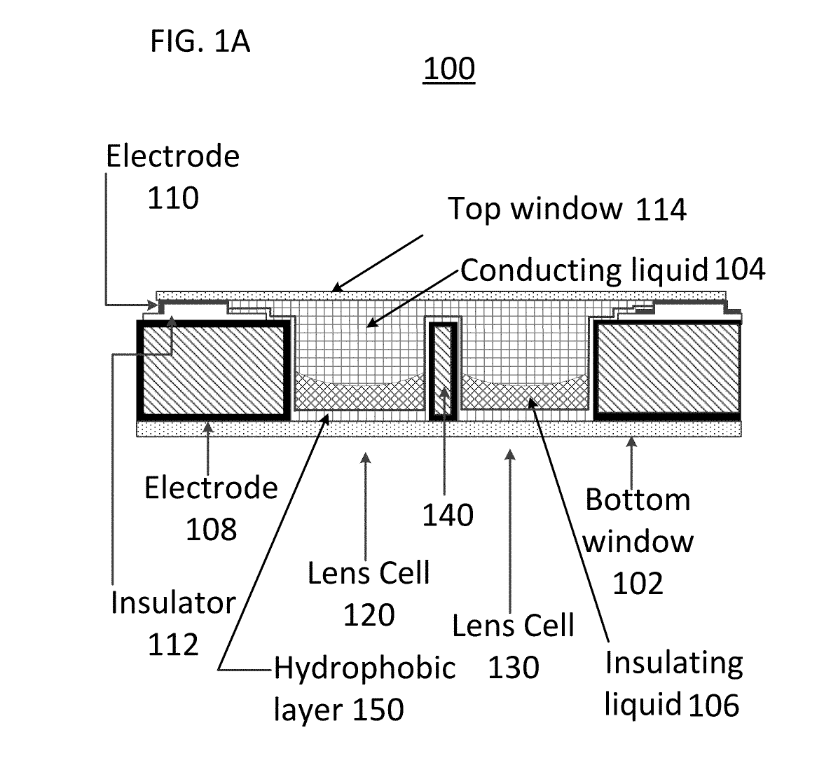

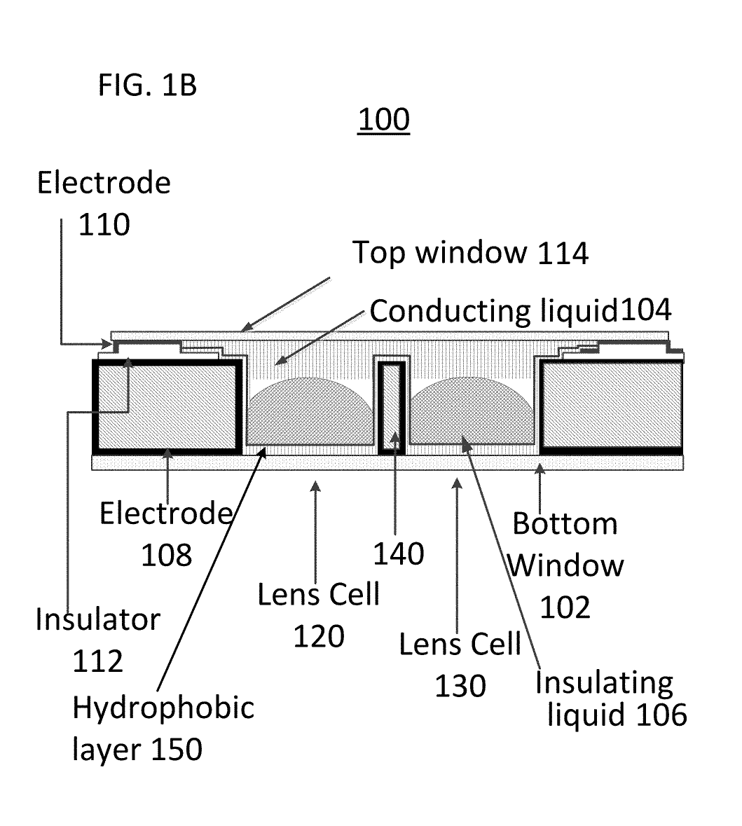

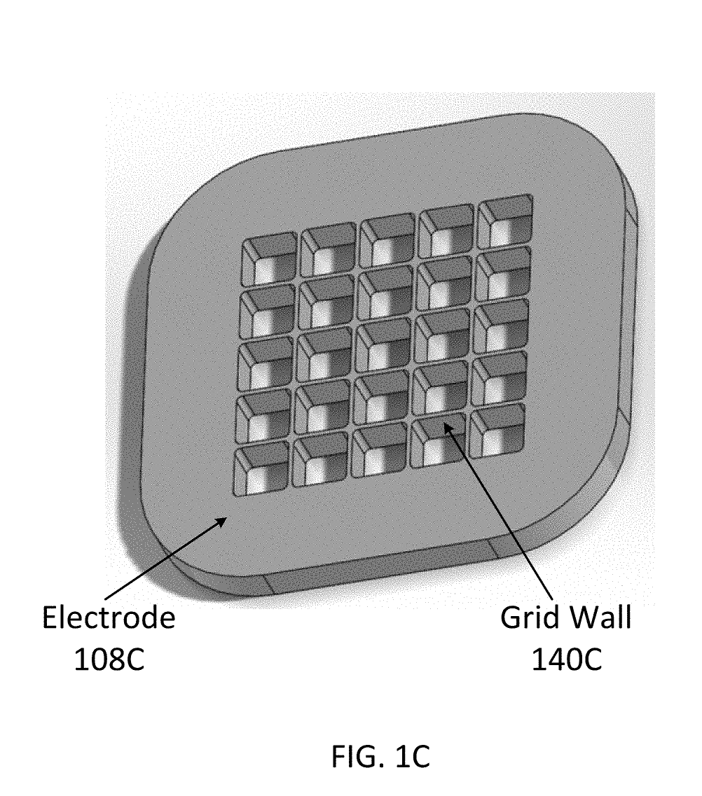

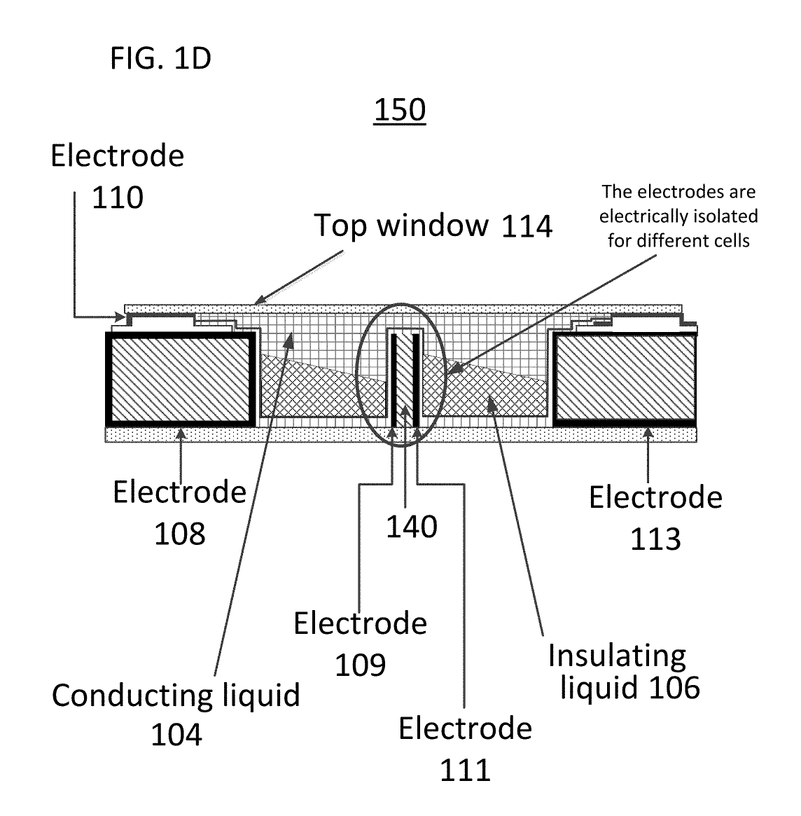

Shown in Applicants' FIG. 1A is a cellular electrowetting lens array 100. The simple example includes two lens cells 120 and 130 separated by a cellular grid wall 140. The cells 120, 130 are formed between a first window 102 and a second window 114. The first window 102 and the second window 114 may both be made of glass or other transparent/non-transparent and/or conductive/non-conductive material. The first window 102 is a bottom window, and the second window 114 is a top window, in the illustrated orientation. Of course, the electrowetting lens array 100 may be oriented in an inverted manner (102 on top and 114 at bottom) or in any other manner suitable for passage of light through the lens array in a direction intended or desirable for a particular application of the array.

Although not shown in the example of FIG. 1A, conductive material for one or more electrodes and/or wiring for electrical connections to various device electrodes may be formed on a surface of either or both of the windows 102, 114, for example, using a transparent conductive material. When a conductive material is being used, deposition of an extra isolation layer may or may not be beneficial depending on the application. For example, deposition of an extra isolation layer may be beneficial in a beam steering application. In a beam shaping application, the conductive material itself could work as the electrode.

The electrowetting lens array 100, in the illustrated example, also includes a first electrode 108. In this first example, the electrode 108 and/or any supporting structure on which the material of the electrode forms a substantial portion of the lateral wall(s) of a liquid container. For that purpose, in the example, the electrode has a proximal surface attached to the first or bottom window 102 so as to form a liquid tight seal. The first electrode 108 has one or more inward facing surfaces encompassing an interior space. In an example (see e.g. FIG. 1C), the array uses a single first electrode that encompasses the interior space. Other arrangements use a single substrate on which the first electrode 108 is formed on appropriate inner surface(s). Other configurations of the array 100, however, may use a number of first electrodes that together encompass a significant portion of the interior space. Using a number of first electrodes may provide an additional degree of control of the voltage and thus the operation of the cells of electrowetting array, however, the use of additional electrodes requires use of additional wiring and more complex control algorithms.

The electrowetting lens array 100 in the first example also includes an insulator 112, in this case, mounted on the distal surface of the first electrode 108. The insulator provides electrical isolation of the electrode 108 from at least one second electrode 110 mounted on the insulator 112, in the example. The second electrode 110 provides an electrical connection to the conductive liquid 104. Similar to the first electrode 108, the example uses a single second electrode 110; although other array configurations could use a number second electrodes.

The second window 114 is attached or mounted adjacent to the second electrode 110 in a manner to form another liquid tight seal. The windows 102, 114, electrodes 108, 110 (and any supporting structure not separately shown), and insulator 112 together form a liquid container having an interior volume including the interior space encompassed by the one or more inward facing surfaces of the first electrode 108. The liquids 106, 104 together fill the interior volume of the liquid container, for example, with little or no entrapped gas. As outlined earlier, the first liquid 106 is an insulating liquid, and the second liquid 104 is a conductive liquid; and in the examples, the first (insulating) liquid 106 has a higher index of refraction than the second (conductive) liquid 104.

The first (insulating) liquid 106 may be a suitable oil. Suitable fluids for use as the second (conductive) liquid 104 include alcohols, glycols, ionic liquids, or other suitable materials that can conduct electrical or ionic charges adequately to enable the electrowetting operations described herein. Conducting fluids may contain salts or other additives to alter their electrical conductivities. Specific examples of relatively insulating fluids that may be used include relatively non-conductive ‘oil,’ liquids such as Dow Corning OS-20, Dodecane, and silicone oil. Specific examples of relatively conductive fluids that may be used include aqueous solutions for the more conductive liquid, such as: aqueous mixtures of Sodium Dodecyl Sulfate (SDS), Aqueous mixtures of Potassium Chloride (KCl), and Propylene Glycol (PG).

The electrowetting lens array 100 also includes a grid wall 140 inside the interior volume of the liquid container. The grid wall 140 extends from one of the windows, e.g. from window 102, at least partially across the interior volume toward the other of the windows, e.g. toward window 114. The grid wall 140 is located so as to divide the interior volume of the liquid container into individual electrowetting lens cells. Each of the lens cells 120 and 130 are filled with some of both the insulating liquid 106 and the conductive liquid 104.

In this example, the outer electrode 108 surrounds the fluidic system and forms a part of the container wall structure. The outer electrode 108 may be formed in various ways, for example, as a solid metal component or as a metal coating at the appropriate location(s) on surface(s) of a suitable substrate. Within the interior of the liquid container, the wall 140 divides the fluidic system into cells of the array. In the example, the array includes only two cells 120 and 130, and the wall 140 is shown approximately in the center of the fluidic system. In other examples of arrays with larger numbers of cells in each one or both dimensions of the respective arrays, walls like 140 form a two dimensional grid of cells (see e.g. FIG. 1C). In the example of FIG. 1A, although the grid wall 140 divides or separates the fluidic system include cells 120 and 130, the wall 140 does not extend all the way between the inner surfaces of the bottom window 102 and the top window 114 and allows fluid communication of one fluid (e.g. of conductive fluid 104) between adjacent electrowetting cells 120 and 130 of the array 100. However, in the example, wall 140 extends far enough to block fluid communication of the non-conductive fluid (e.g. fluid 106) between the cells.

In an alternative example, the grid wall may also extend from window 114 partially to window 102, thus leaving cells with separate volumes of conductive liquid and connected volumes of insulating liquid. However, in that example, all volumes of conductive liquid would be connected with electrode 110 via separate leads or via a transparent conductive film on the inside of window 114.

In the example actually shown in FIG. 1A, the grid wall 140 separates insulating liquid 106 in lens cell 120 from insulating liquid 106 in lens cell 130, although there is a continuum of the conductive liquid 104 in the lens cells 120 and 130.

The grid wall 140 may be formed of the same material as (or even integral with) the electrode 108. In other arrangements, the grid wall 140 may be separate and/or formed of a different material. The grid wall may be constructed of glass or metal or the like. In an array for an imaging application, it may be preferable to have grid walls that are as transparent as possible, to minimize image distortions and reduce optical loss. Also, for lighting applications, transparency could help by reducing light loss. If the grid walls are made from non-transparent material, then it may be preferable to have thin grid walls that do not block too much light. In the examples herein, the array 100 is intended for non-imaging applications, such as beam shaping or steering of light to be output from a general illumination type light fixture or other luminaire. For such applications, if non-transparent material is used, the cellular grid wall 140 has relatively high reflectivity to enhance extraction of light for output from the array 100.

The array 100 in the example also includes a hydrophobic layer 150. A hydrophobic material is a substance that is not attracted to a polar liquid such as water. A hydrophobic material or layer thus may appear to repel water. In the absence of another force, a drop of water on a surface of a hydrophobic material exhibits a high contact angle with respect to the surface. Examples of a hydrophobic material, for electrowetting applications such as in the array 100, may also be an electrically insulating dielectric material. In such an example, the hydrophobic dielectric layer 150 extends across surfaces within the container that otherwise would be exposed to at least one of the liquids. The surfaces covered by the hydrophobic dielectric layer 150 in our example include surfaces of the window 102, the electrode 108, and the grid wall 140. Surfaces of the insulator 112 may also be covered by the hydrophobic dielectric layer 150.

Rather than having electrodes for each individual cell of the array, the cellular array in the example of FIGS. 1A and 1B has only one set (pair in the example) of electrodes 108, 110 for the entire array 100, although some implementations of an array may have additional electrodes around the perimeter of the array. The grid wall 140 divides the fluidic system into cells 120, 130; but the one set of electrodes 108, 110 applies the selected electric field across all of the cells 120, 130 of the fluidic system at the same time. In a later example, the grid wall 140 is formed as an integral element, e.g. as part of a single metal component, together with the portions of the electrode 108 shown in cross-section in FIGS. 1A and 1B. In such an arrangement, the grid wall 140 also serves as part of the electrode 108. Although the field may vary somewhat across the extended array 100 and thus vary the performance of the liquids within different cells a bit, the liquids 104, 106 respond substantially in the same manner/degree at the same time within all of the cells 120, 130 of the array 100. Use of a conductive grid wall 140 coupled to/integrated with the electrode 108 may help more evenly distribute the same electric field across the cells 120, 130 of the array 100.

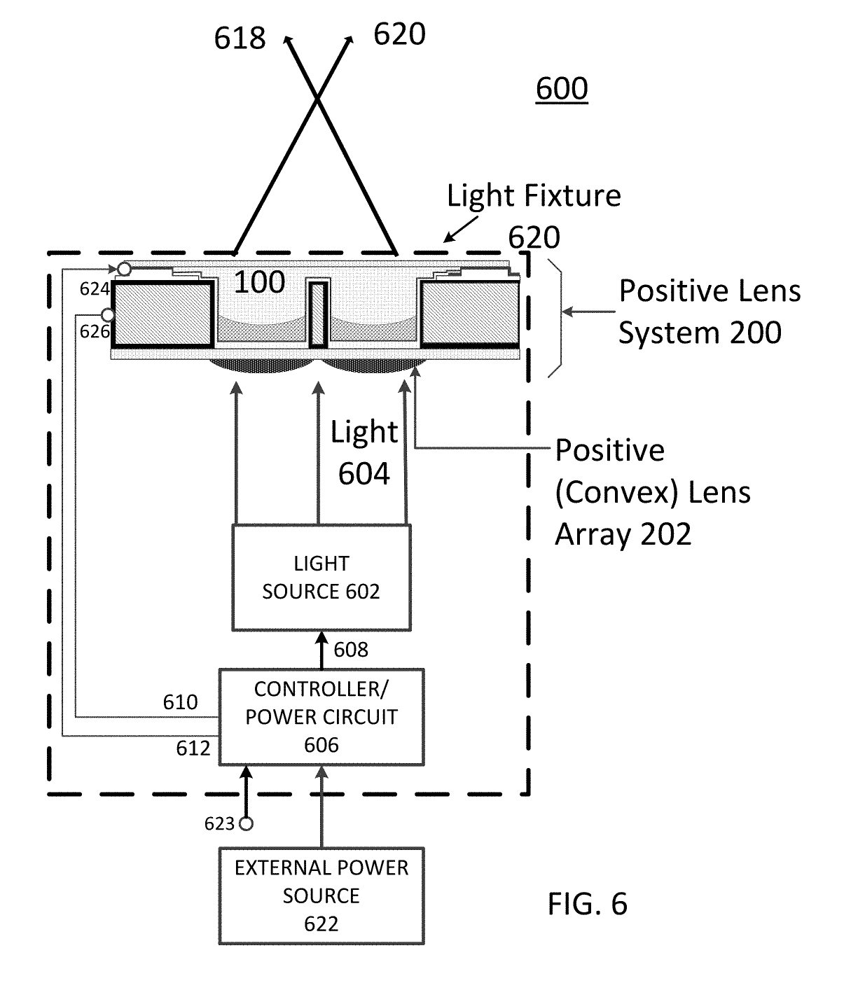

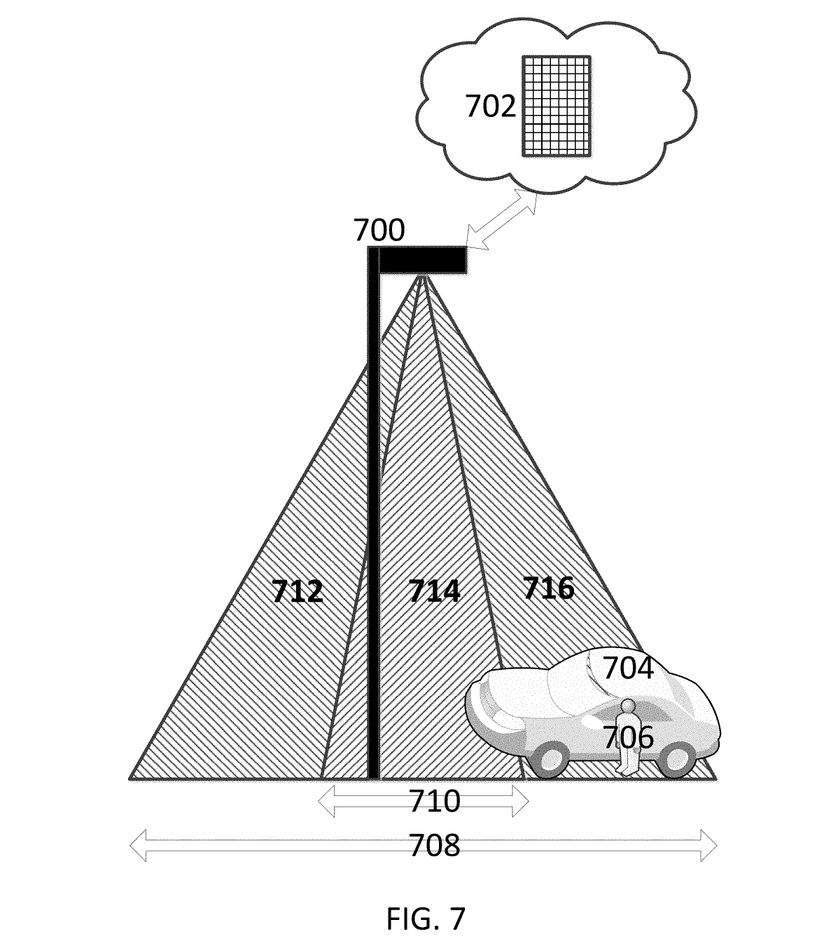

In general, the electrodes 108, 110 are configured to receive a voltage from a power source (not shown, but associated with or part of controller 606 in FIG. 6). The conductive liquid 104 contacts electrode 110 to create an electric field across the insulating liquid 106 and the hydrophobic dielectric layer 150. In this way, the voltage applied to the electrodes 108, 110 creates an electric field that imparts a force to at least one of the liquids. In the example of array 100, this forces changes the shape of the conductive liquid 104 which forces changes in shape in the non-conductive liquid 106. More specifically, the first electrode exerts a force on the conductive liquid 104. Due to this force, the conductive liquid 104 changes shape; and, because of the change in shape of the conductive liquid 104, the non-conductive liquid 104 will follow and also change shape. The interface between the two liquids 104, 106 forms the lens, and the shape of this interface in a given electrical field state determines the optical power of the lens in each cell 120 or 130 in that state. Due to the division into cells by the wall 140, the force changes the shape of the conductive liquid 104 within each cell of the array 106 thereby modifying a focal point of light passing through the windows and the liquids in the cells of the array 100.

With specific reference to FIG. 1A, when a first non-zero voltage is applied to electrodes 108 and 110, the force on the conductive liquid 104 in both lens cells 120 and 130, created by the electric field, changes. With one voltage polarity, conductive liquid 104 in lens cells 120 and 130 exhibits a convex shape. This convex shape exhibits the optical properties of a negative optical lens (due to the lower index of refraction of conductive liquid compared to insulating liquid), where collimated light transmitted from bottom window 102 into cells 120 and 130 is dispersed through top window 114 as a wide beam of light. This negative state of lens cells 120 and 130 may be beneficial in applications where a wide output light beam is desirable.

FIG. 1B illustrates the same electrowetting array 100 as in FIG. 1A, however, a second voltage (e.g. of the opposite polarity) is applied to electrodes 108 and 110 that changes the force applied to the conductive liquid 104 in both cells 120 and 130 in a different manner from that of FIG. 1A. Specifically, conductive liquid 104 in cells 120 and 130 exhibits a concave shape. This concave shape exhibits the optical properties of a positive optical lens (due to the lower refraction index of liquid 104 compared to liquid 106), where collimated light transmitted from bottom window 102 into cells 120 and 130 is focused through top window 114 as a narrower beam of light. This positive state of lens cells 120 and 130 may be beneficial in applications where a narrow focused output light beam is desirable.

Switching between the negative state and the positive state shown in FIGS. 1A and 1B is essentially accomplished by controlling a voltage source across electrodes 108 and 110 of the electrowetting array 100. At zero volts, the insulating liquid 106 in lens cells 120 and 130 exhibits a somewhat concave shape thereby somewhat widening the output light beam angle output from top window 114. As voltage is increased across electrodes 108 and 110, insulating liquid 106 in lens cells 120 and 130 becomes less concave and eventually begins to exhibit more of a convex shape (see FIG. 1B). For example, with collimated incoming light, the output beam angle is initially wide when zero volts is applied to the electrodes. As the voltage increases from zero volts, the insulating liquid becomes less concave resulting in a decreasing beam angle. With further increases in voltage, the insulating liquid starts to become convex in shape resulting in the beam angle once again increasing.

FIG. 1C shows a view of an example of an integral electrode and grid structure, that may be used in an array as in FIGS. 1A and 1B. The integral structure in FIG. 1C includes a solid metal electrode 108C also forming an outer wall of the liquid container volume of the electrowetting optic. The integral structure also includes grid walls 140C dividing the volume into an array of cells, each cell having a substantially square shape, although other closed shapes may be used (e.g. round, triangular, octagonal, etc.). In this integral construction, the electrode 108C is electrically connected to the grid walls 140C of the cell array, so that the grid wall essentially becomes another component of the electrode.

The example shows a 5×5 array of cells. The cells in the example have rounded corners but are otherwise square. The walls of the cells may be reflective. The electrode and gird wall structure for electrowetting lens array can be manufactured to have a specific size, shape, dimension, etc. to appropriately accommodate any lighting application. For example, the electrowetting lens array can be manufactured to fit within a specific light fixture typically utilized by stores, home owners, etc., where the light fixture incorporates a particular lamp.

For example, each cell may have a surface or cross-sectional area extending across the path of light passing through the cell greater than 64 mm². Assuming square cells, as an example, such cells would be 8 mm×8 mm or larger in one or both dimensions. FIG. 1C shows the electrode 108C and grid walls 140C forming a 5×5 array of such cells as may be used, for example, with a MR16 light source or other similarly sized type of light source in a general illumination type luminaire. For example, the electrowetting cells could be expanded to much larger dimensions (e.g. 2, 4, 6, 8 inches, etc.), which may be beneficial in applications where the array is used in conjunction with larger light source in large sized luminaires.

The walls within each electrowetting lens cell may be manufactured with glass and/or with metal having a specified reflectivity (e.g. 90% or higher) to optimize light output. For some applications, some or all of the cell walls may be transparent, although in the integral metal example, they may be reflective. Hence, for lighting applications of the array using a metal, the high reflectivity of the walls helps improve the efficiency of passage of light from the source through the array and thus the overall efficiency of a luminaire or the like that incorporates the array. Also, the depth of each electrowetting lens cell may be greater than half of the electrowetting lens cell size itself in beam steering and beam shaping applications. If the cells have tilted side walls, however, the thickness may be reduced. In beam shaping applications, the depth of each electrowetting lens cell may be around the half of the electrowetting lens cell size itself.

The electrowetting array includes power terminals for connecting the electrodes in the electrowetting lens cells to at least one of a residential power source, commercial power source and solar power source. In addition, the lens array may be at any distance (e.g. 5-15 cm) from the light source, for example, in a fixture configured as a down-light.

As an alternative to the integral metal structure of FIG. 1C, an electrowetting optic like that of FIGS. 1A and 1B may use a molded transparent non-conductive member (e.g. acrylic or glass), integrally forming the container wall and grid walls for the array of cells. The integral member may also include a section essentially forming one of the transparent windows. In an example of this type, metal serving as the electrode may be a coating on one or more appropriate surfaces of the molded transparent non-conductive member, e.g. on an inner wall of the container and/or on lateral surfaces of the grid walls.

FIGS. 1A and 1B show the electrowetting lens array having an electrode 108 common to all sides of the cells within the array. As noted earlier, the grid wall 140 may be formed of the same material as (or even integral with) the electrode 108. This configuration is beneficial in applications where narrow and wide beams of output light are required. However, some applications may require beam steering of the output light.

FIG. 1D shows a configuration of a cellular electrowetting lens array 150 that is somewhat different from the electrowetting lens arrays shown in FIGS. 1A and 1B. Most of the components in electrowetting lens array 150 are the same as the components in the cellular electrowetting lens array 100. However, array 150 includes electrically isolated electrodes (108, 109, 111 and 113) in each cell. Electrode 110 may still be a common electrode for the cells of the array. Each of the electrically isolated electrodes facilitates application of an independent (e.g. optionally different) voltage to a different portion of each cell. In the example, the voltages produce a liquid shape that is controllable so as to provide variable prismatic properties, represented by straight lines at the interfaces between the liquids in the various cells. This essentially provides a mechanism for performing beam steering of the output light. Although the example shows prismatic beam steering control, some implementations of the cells in the array may be controllable so as to also provide variable lens type properties to concurrently adjust focus and thus beam-shape of light passing through the cells of the array 150.

Returning to the illustrated example, when performing beam steering, the system applies a voltage differential between the electrodes in each cell to create a non-uniform distribution of the liquids in each cell. This non-uniform distribution changes the shape of the liquid 106 in the respective cell and thus the angle of the prism formed by the liquid 106 at the interface with liquid 104. The adjusted prism redirects the incoming light to a different output angle (e.g. to the left/right of electrowetting lens array 150). For example, as shown in FIG. 1D, the voltage applied to electrode 108 may be smaller than the voltage applied to electrode 109, and the voltage applied to electrode 113 may be larger than the voltage applied to electrode 111. This voltage differential imparts differing forces on the fluids and therefore creates a non-uniform distribution of the fluids in each cell like the angled prisms shown in the cells in the drawing. The light that enters electrowetting lens array 150 is thereby steered to one side (e.g. to the left for FIG. 1D) of the electrowetting lens array 150 upon exiting the top window 114.

It should be noted that in practice, lens array 150 is a two dimensional array having (N×M) electrowetting lens cells. Thus, in order to steer the output light beams in two dimensions, each cell (assuming each cell is a square or a rectangle) will have electrically isolated electrodes on each side of the cell. This configuration allows the electrowetting lens array 150 to steer the light beam in any two dimensional space. It also should be noted that the electrical isolation of the electrodes could be arranged on a column/row basis and rather than on a cell by cell basis to simplify the design. This would allow the system to steer a particular column/row of cells to steer the light beam.

As outlined in the discussion of FIGS. 1A-1D, a cellular electrowetting lens or prism array may be implemented with any number of electrodes, from two electrodes for the entire array up to a desired number for each cell of the array.

The state of the liquid 106 in FIG. 1A acts as a concave optical lens which has a focal distance:

f1=−R1/Δn Equation 1

where R1 is the radii of curvature of the oil in the concave lens and Δn is the refractive index difference between oil and water. The marginal optical ray passing through the lens is refracted to have a maximum output angle value of θ₁.

In contrast, the state of the liquid in FIG. 1B acts as a convex optical lens which has a focal distance:

f2=R2/Δn Equation 2

where R2 is the radii of curvature of the oil in the concave lens and Δn is the refractive index difference between oil and water. The marginal optical ray passing through the lens is refracted to have a maximum output angle value of θ₂.

From the equations, it is determined that the focus f1 of the concave lens in FIG. 1A has a negative value, while the focus f2 of the convex lens in FIG. 1B has a positive value. Although near the lens there may be no overlap, this arrangement results in an overlap in the tunable range of the lens in the far field, which is equivalent to the maximum value of the output marginal ray angles θ₁ and θ₂. Thus, due to the overlap in the far field, the overall tunable range in the far field is not optimized.

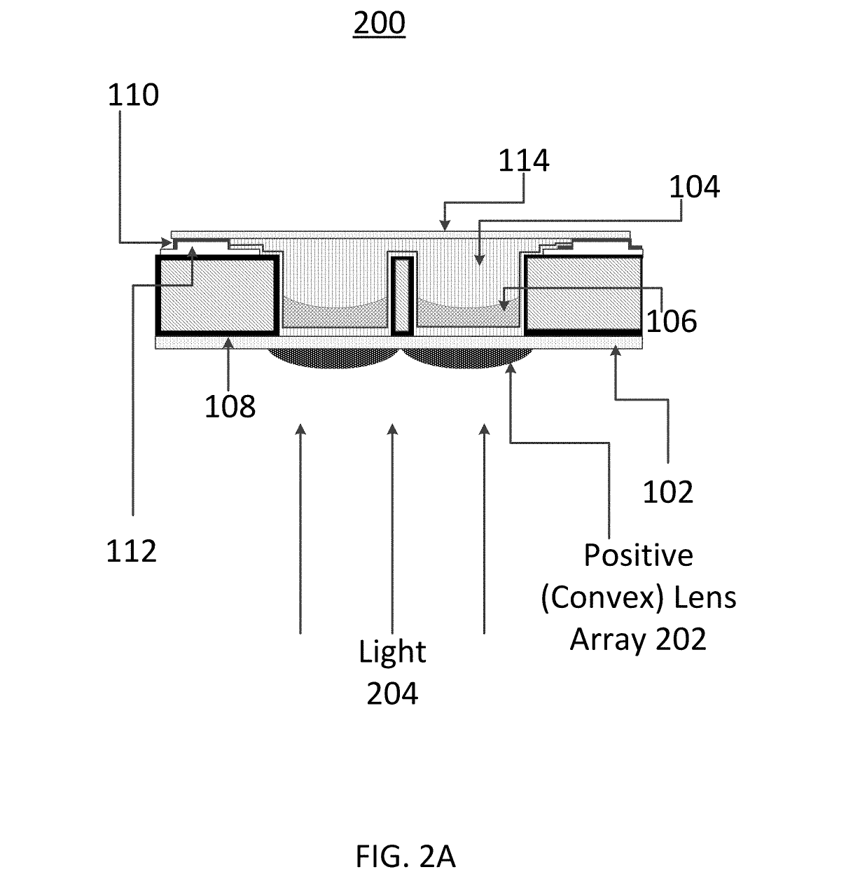

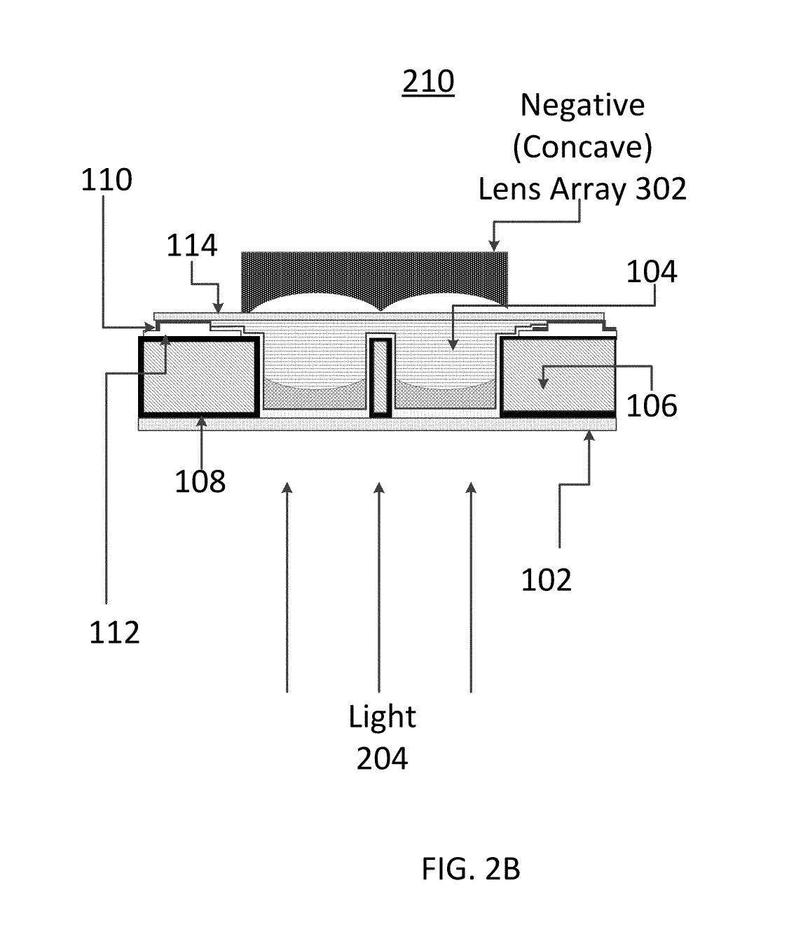

In order to optimize (e.g. typically, to increase) the output tunable beam angle range in the far field of the lens, which is proportional the marginal ray angle, the electrowetting array 100 shown in FIG. 1A is combined with either a positive optical lens array 202 shown in FIG. 2A, or a negative optical lens array 302 shown in FIG. 2B to further process light 204. In the examples, the positive and negative lens arrays are arrays of fixed lenses, e.g. made of glass or similar rigid transparent material amenable to manufacture in the desired shapes. The lenses of the fixed lens array 202 are positive lenses in that each lens has a convex shape on at least one surface through which light passes. The lenses of the fixed lens array 302 are negative lenses in that each lens has a concave shape on at least one surface through which light passes. In these examples, the individual lenses of the array 202 or the array 302 are aligned for optical coupling with individual cells of the electrowetting cell array, e.g. with cells 120 and 130 in the examples of FIG. 1A to 1D.

As a first example, by combining the positive lens array 202 with electrowetting array 100, a positive electrowetting lens array system 200 is produced in FIG. 2A where the focus ‘f’ for the system is computed by:

1/fs=1/f1±1/f2−d/(f1*f2) Equation 3

As can be seen from equation 3, the focus fs of the positive electrowetting lens array system 200 is always a positive value with a properly selected focus of the positive optical lens and distance between positive lens and electrowetting lens. Thus, it does not matter whether the state of conductive liquid 104 is convex (negative state as shown in FIG. 1A) or concave (positive state as shown in FIG. 1B), because the overall optical system output always exhibits the characteristics of a positive lens array. This ensures that there is no far field overlap in the beam angle output between the concave or convex liquid state. Thus, the tunable range of the marginal ray angle θ is larger than the maximum of θ₁ and θ₂ above. As a result, the tunable range of the output beam angle in the far field increases. An additional advantage of the additional positive lenses is that incoming light converges into the cells, resulting in a smaller loss of light reflecting off the top of the grid walls. Especially for grids with relatively thick walls, arrays of positive lenses could help reduce light loss. For lighting applications, this can be a very helpful method, because it would allow for manufacturing of grids using methods that would otherwise result in unacceptably thick walls. In this respect, positive lenses may have advantages over negative lenses.

In the example of FIG. 2A, the positive lenses of array 202 are located adjacent to window 102 that is receiving light from the source. As noted, that location of the positive lens array 202 helps improve the tunable angular range achievable via the device 200. Alternatively, the positive lens array 202 may be located on the output side of the device 600 adjacent to the window 114. In this later arrangement, the positive lenses of array 202 may still help improve the tunable angular range achievable via the device 200, although they do not help channel the light so as to avoid the grid walls.

FIG. 2B shows a negative lens array system 210, which includes both a cellular electrowetting lens array (similar to the electrowetting array of FIGS. 1A and 1B) and an associated negative lens array 302. With a properly selected focus of the negative lens array and difference value, this essentially creates a negative electrowetting lens array system 210 that always acts at a negative lens array. Therefore, the focus fs is always a negative value and therefore there is still no overlap in the output beam angle θ for the far field situation. This effectively produces a tunable beam angle range equivalent to the range produced by the positive system in FIG. 2A. Regardless of the negative or positive configuration, positive electrowetting lens array system 200 in FIG. 2A and negative electrowetting lens array system 210 in FIG. 2B could have a tunable beam angle range that is substantially equivalent depending on the chosen focus. The choice between using the positive lens array or the negative lens array configuration is up to the designer of the system. It should be noted that the positive and/or negative optical lens array may be manufactured from any material (e.g. glass) and may have any shape (e.g. spherical or aspherical). A general advantage of a positive over a negative array is that it can reduce light reflections off the top of non-transparent grid walls, or, in case of transparent grid walls, increase the amount of light that passes through the variable lens rather than through the walls.

FIGS. 2A and 2B show a combination of the cellular electrowetting lens array 100 with the positive fixed lens array 202 or the negative fixed lens array 302. It should be noted, however, that alternatively electrowetting prism lens array 150 of FIG. 1D, with beam steering capabilities, may also be combined with positive array 202 or negative array 302.

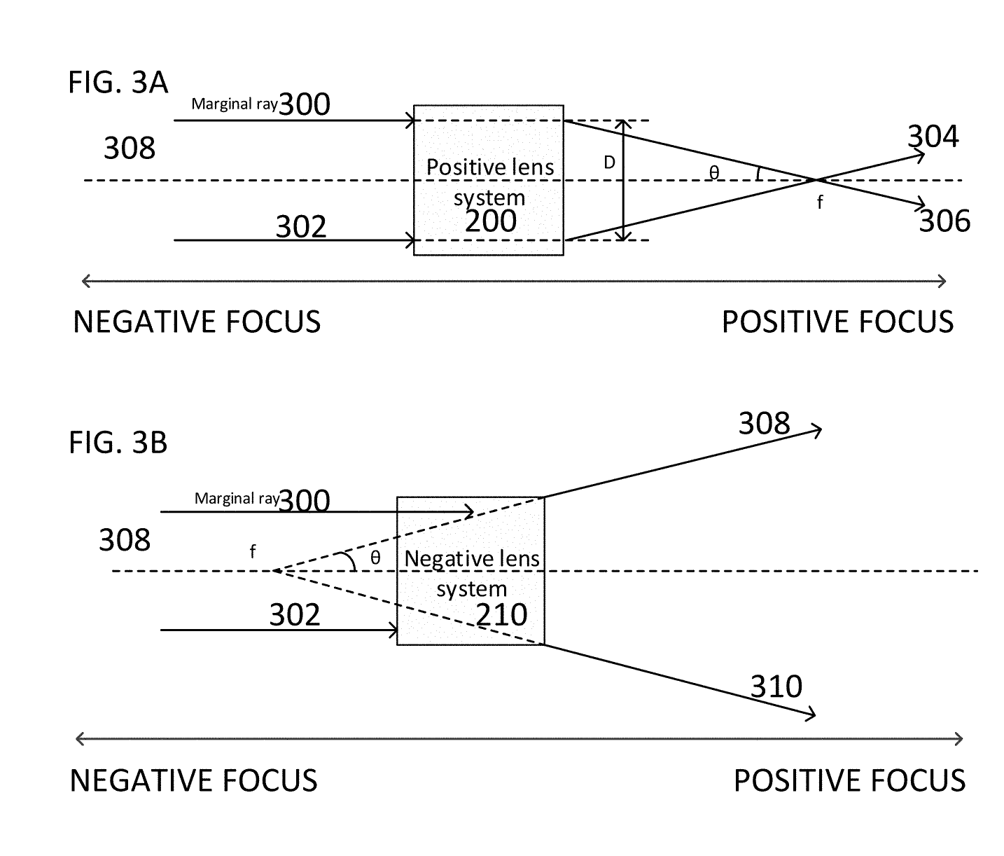

Shown in FIGS. 3A and 3B are theoretical calculations for the positive lens system 200 shown in FIG. 2A and the negative lens system 210 shown in FIG. 2B. With a positive lens system 200, as shown in FIG. 3A, the collimated light rays 300 and 302 enter the overall system through positive lens array 202, transmitted through first (e.g. bottom window) 102, transmitted through lens cells 120 and 130, and then transmitted through second (e.g. top) window 114 where the light is output as light beams 304 and 306 that converge at a focal along center line 308.

The output angle of marginal ray 304 and 306 denoted as θ is computed as:

θ=arc tan(D/2f) Equation 4

where the focus of light beams 304 and 306 is at a distance from the lens denoted as T, the distance between beams is denoted as Tr. As voltage is applied to electrodes 110 and 108, focal distance ‘f’ ranges from a small positive number to produce a larger θ or large positive number to produce a smaller θ. It should be noted that focal point does not enter the negative focus region due to the effects of the positive lens array 202. This ensures that distance ‘f’ is always positive and therefore there is no overlap in θ.

The negative lens system 210 in FIG. 3B behaves similar to the system shown in FIG. 3A but with a divergence rather than a convergence. Input light rays 300 and 302 enter lens cells 120 and 130 through first (e.g. bottom) window 102, pass through the negative lens array 302 shown in FIG. 2B producing output light beams 308 and 310 which radiate through second (e.g. top) window 114. The negative lens system has a virtual focal point at a negative distance ‘f’ from the lens. As the voltage is applied across electrodes 110 and 108, focus f ranges from small negative number to produce a larger θ or a larger negative number to produce a smaller θ. It should be noted that focus ‘f’ does not enter the positive focus region due to the effects of the negative lens array 302. This ensures that ‘f’ is always negative and therefore there is no overlap in θ.

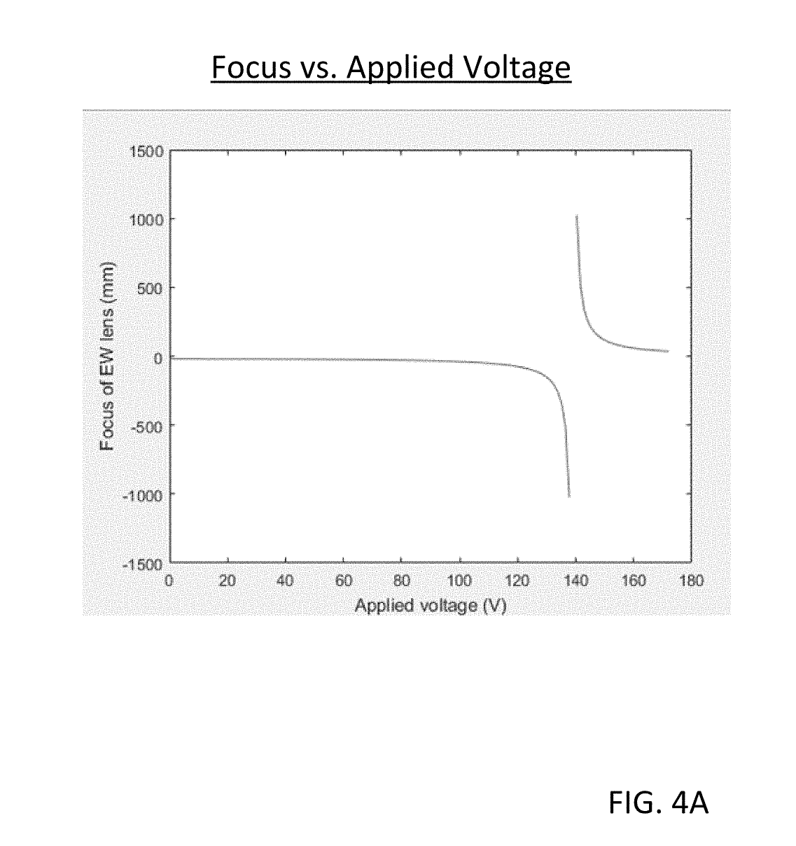

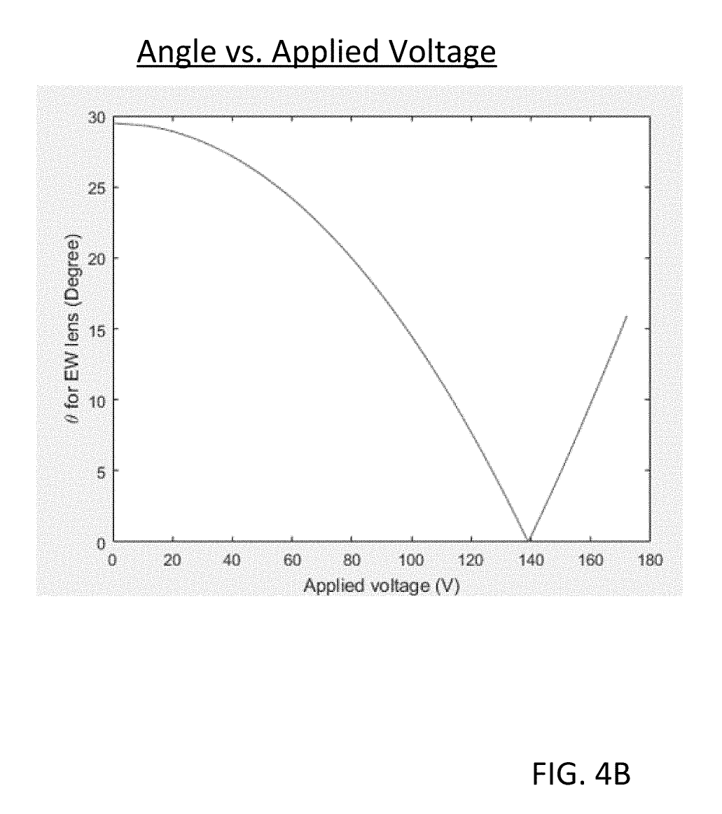

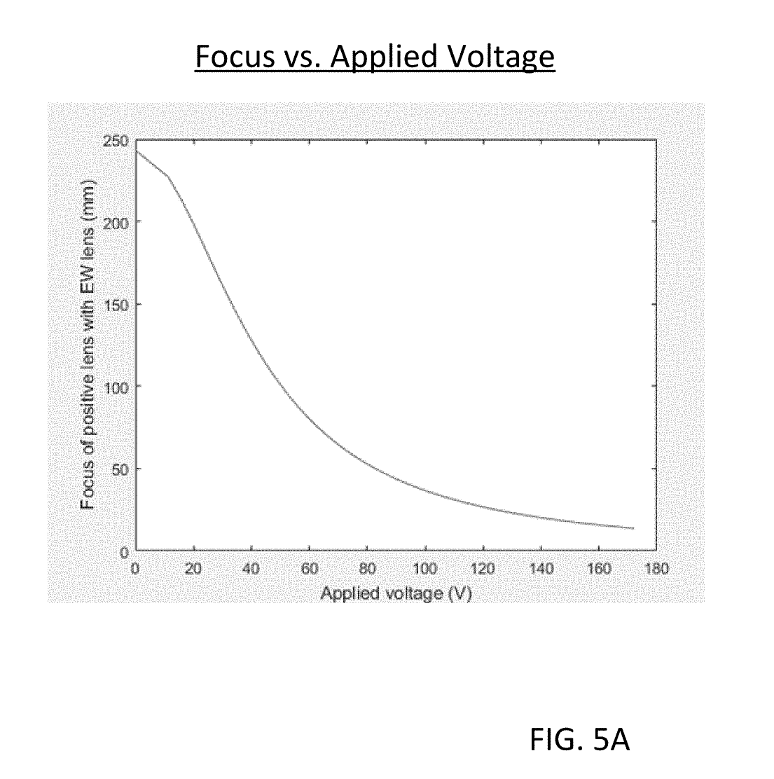

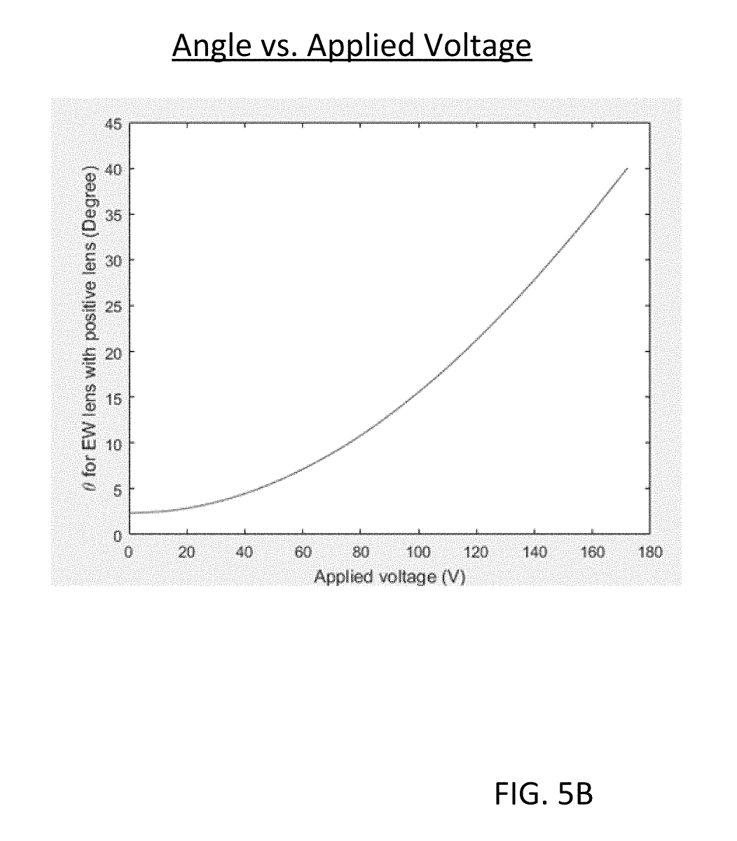

FIGS. 4A, 4B, 5A and 5B show theoretical results for the focus ‘f’ and output angle θ of the electrowetting array 100 shown in FIG. 1A and the positive electrowetting lens array system 200 shown in FIG. 2A. For electrowetting lens 100 shown in FIG. 1, the focus as can be seen in FIG. 4A as switching from a negative value to a positive value at around 140 v applied to the electrodes. This effectively produces overlap in the output marginal ray angle θ shown in FIG. 4B. Essentially, the marginal ray angle θ starts at approximately 30°, decreases to approximately 0° and then begins increasing again at 140v. Thus, the overall effective tunable range for the marginal ray angle of the electrowetting array 100 at any given voltage is only 0°-30°.

In contrast, positive electrowetting lens array system 200 shown in FIG. 2A has a positive focus. This is shown in FIG. 5A where the focus decreases from approximately 250 mm towards 0 mm. By having a positive focus, this results in output marginal ray angle θ that does not have overlap. As shown in FIG. 5B, the output marginal ray angle θ for the positive electrowetting array system 200 increases from 0° up to about 40°. Thus, the overall tunable range of output marginal ray angle θ is 0°-40° (10° greater tunable range than the system that does not include the positive lens array).

Although not shown, substantially similar results would occur in simulating the negative electrowetting lens array system 210 shown in FIG. 2B. The difference is that the focus ‘f’ is always negative, and therefore the output marginal ray θ decreases with increasing voltage. Thus, similar to the simulation shown in FIGS. 5A and 5B, there is no overlap in the output beam angle θ thereby resulting in a tunable output light beam range of 0°-40°.

It should be noted that the cellular electrowetting lens array may be manufactured in various shapes, sizes and dimensions. The shape, size and dimension of the electrowetting lens array may be defined by a particular lighting application. For example, the electrowetting lens array may be manufactured in a specific shape and size and dimension to facilitate a predetermined amount of output light (e.g., lumens) for a particular residential or commercial lighting fixture using a specified light source. The electrowetting lens array, for example, may be square in shape (FIG. 1C above) in order to be appropriately mounted on a square light fixture or may be round for other lighting applications. Of course, other overall shapes are possible. In the examples, the light emitted from the light fixture enters the electrowetting lens array through the bottom window and is then appropriately processed by the lens cells in the array to either output a narrow or wide light beam, although other orientations are contemplated for particular artificial lighting applications.

For example, the electrowetting lens arrays or systems shown in FIGS. 1A, 1B, 2A and 2B are manufactured in various shapes, dimensions (e.g. number of cells per array), sizes (e.g. overall array length/width), and cell shapes to accommodate residential and commercial lighting applications (e.g. combination with various light sources to form different types of luminaires). For example, the size (e.g. length, width and depth) of the electrowetting lens array may be set in accordance with the length, width and depth of a particular light fixture to which the array will be mounted. This ensures that the electrowetting lens array system will physically fit inside or on the outer light emitting face of the light fixture. For example, if a manufacturer wants to develop a light fixture that has a square shape front face of approximately 20 cm×20 cm, then the electrowetting lens array can also be designed and manufactured square in shape, with dimensions just less than 20 cm×20 cm to properly fit within/on the fixture.

In contrast, the light fixture can be designed in relation to the size of the electrowetting lens array or system itself. For example, if electrowetting lens arrays and/or positive/negative lens systems are mass produced having predetermined sizes and shapes, then lighting manufacturers can design light fixtures that will properly accommodate these electrowetting lens array systems. Generally speaking, making the size (e.g. length/width/depth) and shape (e.g. square, round, triangular, octagonal, etc.) of the electrowetting lens array or system roughly equivalent to the light emitting face of the light fixture ensures that the output light is optimized.

Although the cellular electrowetting lens array or positive or negative lens system may be manufactured to fit inside a light fixture during manufacturing, it should be noted that the electrowetting lens array may also be manufactured to retrofit on an already existing light fixture. For example, a light fixture that is already installed out in the field may be retrofitted with an electrowetting lens array system that is either mounted internal to the light fixture or external (e.g. on the outer light emitting face) of the light fixture. The electrowetting lens array or system (including a controller) can be screwed onto the light fixture itself, and then electrically connected to the light fixture power source. This provides retrofitting abilities for legacy light fixtures to have beam shaping capabilities over a large tunable range.

For example, in one scenario, an electrowetting lens array may be fitted to a residential light fixture (e.g. a kitchen light fixture), to selectively control the light output distribution of the particular type of light fixture. In one example, the kitchen occupants may desire a wide beam of light to illuminate the entire kitchen. For a negative lens system, in order to achieve a wide beam of light, configuration, the occupant may flip a switch or turn a knob (not shown) on the kitchen wall, or push a button on their smartphone that controls the switch or knob which sends a voltage signal (e.g. zero volts) to the electrowetting lens array to force the insulating liquid in the cells into a negative state, thereby widening the light beam output by the light fixture. In another example for the negative lens system, the kitchen occupants may desire a narrow beam of light to illuminate just a limited area on the counter top. In order to achieve a narrow beam, for example, the occupant may flip the switch or turn the knob on the kitchen wall which sends a different voltage signal (e.g. greater than zero volts) to the electrowetting lens array to force the insulating liquid in the cells into a positive state, thereby narrowing the light beam output by the light fixture.

In another scenario, an electrowetting lens array or system may be fitted to a commercial light fixture (e.g. a high-bay light fixture for a big box store or the like). In one example, the store employees may desire a wide beam of light to illuminate an entire isle. For a negative lens system, in order to achieve a wide beam, the employees may flip a switch or turn a knob which sends a voltage signal (e.g. zero volts) to the electrowetting lens array to widen the light beam. In another example of the negative lens system, the employees may desire a narrow beam of light to illuminate just a portion of the isle for a specific product that needs to be highlighted (e.g. for a sale). In order to achieve a narrow beam, the employees may flip the switch or turn the knob which sends a different voltage signal (e.g. greater than zero volts) to the electrowetting lens array to narrow the light beam.

It should be noted that a positive lens system would work similarly to the negative lens system in the illumination application examples described above. The difference between the two systems is that as voltage is decreased towards zero volts, the positive lens system produces a narrower beam, and as voltage is increased, the positive lens system produces a wider beam.

Although the scenarios described above have the electrowetting lens array being manually controlled, it is contemplated that the electrowetting lens array may be remotely and automatically controlled by a remote computer/server (not shown) to perform specific wide/narrow beam shaping functions.

FIG. 6 illustrates an example of a light fixture application including a positive lens system 200, like that shown in FIG. 2A. A commercial or residential lighting application system 600 may include a light fixture with an outer housing or shell 620 made of metal, plastic or the like. Mounted within the light fixture shell 620 are a positive electrowetting lens array system 200, or a negative electrowetting lens array system (not shown), a light source 602. The positive lens array system 200 includes a cellular electrowetting lens array 100 similar to that of FIGS. 1A and 1B in combination with a positive fixed lens array 202.

In this example, the shell 620 also houses a controller/power circuit 606, although the circuit 606 may be separately located and connected to the electrowetting lens array and light source to supply the drive signals thereto. The positive electrowetting lens array system 200 is relatively equivalent in size (e.g. width/depth), and shape (e.g. square) to the light fixture shell 620, although this is not necessary. Mounting of the various components may be performed via screws, adhesive or the like.

The drawing shows an orientation of the lighting application system 600 for emission of light in an upward direction, e.g. to illuminate a decorative feature of a ceiling or to provide indirect illumination by diffuse reflection of light off of a ceiling. Of course, the system 600 may be oriented for light emission in other directions for other lighting applications. For example, an inverse orientation of the system 600 might function as a down-light by outputting light downward for direct illumination, different angles might server for spotlight or wall-wash applications, etc.

Generally, light source 602 is positioned a set distance (e.g. 0 cm-15 cm) behind positive lens array 202 and outputs light beam 604 into the positive lens array. The light is then transmitted through lens cells of the cellular electrowetting array 100 and output as light beams 618 and 620. In order to properly power and control the overall light fixture 600, the controller/power circuit 606 includes appropriate processor based control circuitry (e.g. a micro-control unit or a microprocessor with driver circuitry configured for the particular source and cell array) as well as power circuitry (e.g. AC/DC conversion, Voltage reducing power supply, etc.). Such a circuit 606 is configured to convert power received from external power source 622 (e.g. residential/commercial AC power) to a level that will safely power the light source 602 (e.g. LED light) and positive electrowetting lens array system 200 which both may run on lower AC voltages, DC voltages or AC voltages with a DC offset. The voltage level and possibly the power applied to the light source may be selectively controlled in response to a control signal input shown generally at 623, for example, from a switch, knob, wireless transceiver or the like (not separately shown). Selective control of the voltage applied to the array 100 in response to the signal input and 623 allows selective control of the beam shaping of the light output from the fixture.

In the example, controller 606 is electrically connected to the light source 602 via control line 608 and is also connected to the power electrodes 624 and 626 of positive electrowetting lens array system 200 via control lines 610 and 612. This allows controller 606 to control (e.g. turn ON/OFF, modify light intensity, etc.) light source 602 and the electrowetting properties of the cells in positive electrowetting lens array system 100 to output a light beam with a specified beam angle.

For example, to provide a wide beam of output light, controller 606 may turn ON light source 602 via control line 608 and then apply a voltage to the electrode pairs of lens cells 120 and 130 via control lines 610 and 612 and power electrodes 624 and 626. This allows the oil in lens cells 120 and 130 to relax into a concave shape thereby widening the output beam.

The overall luminaire of FIG. 6 shows the control of the positive electrowetting lens array system. However, it should be noted that a similar structure would be utilized to control the negative electrowetting lens array system 210 shown in FIG. 2B to produce substantially the same output beams in substantially the same tunable range.

Shown in FIG. 7 is an example implementing a light fixture application pf a system including the electrowetting lens array (typically with a positive or negative lens array) in a light fixture for a commercial lighting application, e.g. as a parking lot street lamp. Street lamp 700 overhangs and illuminates a certain area within the parking lot. Street lamp 700 is fitted with a cellular electrowetting lens array which is mounted therein. The shape and size of the array is shown as 702, and is roughly the same shape and size of the output face of street lamp 700.

During operation, the street lamp 700 may be generally set to project a narrow beam of light that covers area 710. However, a motion sensor or the like (not shown) may detect the movement of car 704 and/or of person 706 in the vicinity of the street lamp. This may trigger controller 606 to change the voltage applied to the power terminals of electrowetting lens array 100 to widen the light beam to cover larger area 708. This ensures that the person 706 (e.g. the owner of the car) has proper light for entering or exiting their vehicle. At a later point in time, when no movement is detected, controller 606 may once again change the voltage applied to the power terminals of electrowetting lens array 100 to narrow the light beam to cover smaller area 710. Intensity of the source output may have corresponding adjustments responsive to the motion detection.

As discussed with respect to FIG. 1D, the electrowetting lens array may also be configured to perform beam steering. Electrowetting lens array 150, for example, may be incorporated into street lamp 700 shown in FIG. 7. This provides street lamp 700 with beam steering capabilities. In general, street lamp 700 may steer the light beam through areas 712, 714 and 716 (e.g. to track the motion of user 706). For example, as user 706 approaches vehicle 704 from the left side, street lamp 700 could detect the user's presence and steer the light beam in area 712, then to area 714 as the user gets closer to the vehicle, and finally to area 716 as the user is beside the vehicle. By steering the beam, the user's path to the vehicle can be illuminated.

In general, by implementing an electrowetting optic as a large array of cells as in the examples above, the overall system can be utilized more effectively in lighting applications which than using the electrowetting lenses utilized in the camera industry even if such existing lenses are combined into an array. In addition, by adding a positive lens array or a negative lens array to the electrowetting lens array, the focus is controlled to be always positive or always negative which effectively increases the overall tunable output beam angle range. This provides better performance thereby optimizing the use of the controllable optical system.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A cellular electrowetting array, comprising:
a first window formed of transparent material;
at least one first electrode having one or more inward facing surfaces encompassing at least a portion of an interior volume;
at least one second electrode mounted so as to be electrically isolated from the at least one first electrode;
a second window formed of transparent material,
the windows and electrodes together forming elements of a liquid container containing the interior volume;
first and second liquids, immiscible with respect to each other, together filling the interior volume of the liquid container,
the first liquid being relatively insulating, and the second liquid being relatively conductive, and
one of the first and second liquids having a higher index of refraction than the other of the first and second liquids; and
a grid wall inside the interior volume and extending from one of the windows at least partially across the interior volume toward the other of the windows, located so as to divide the interior volume of the liquid container into individual electrowetting lens cells of the array, each electrowetting lens cell containing some of the first liquid and some of the second liquid,
wherein the electrodes are configured to receive a voltage imparting a force to at least one of the liquids that changes the shape of the insulating liquid within each cell of the array thereby modifying a focal point of light passing through the windows and the liquids in the cells of the array.

2. The array of claim 1, wherein each electrowetting lens cell presents a cross-sectional area greater than 64 mm² to the light passing through the array.

3. The array of claim 1, wherein the grid wall is comprised of at least one of glass or metal having a reflectivity of 90% or greater.

4. The array of claim 1, wherein the grid wall is an integrated component of one of the first and second electrodes.

5. The array of claim 1, further comprising:
a controller/power circuit configured to draw power from at least one of a residential power source, commercial power source or solar power source and to selectively generate the voltage imparting the force to at least one of the liquids; and
power terminals for connecting the electrodes to the voltage generated by the controller/power circuit.

6. The array of claim 1, wherein the grid wall is configured to divide the interior volume of the liquid container such that each individual electrowetting lens cell has a substantially square shape.

7. The array of claim 1, wherein the array is configured to be mounted to at least one of a residential or commercial light luminaire in a manner coupling light from a source within the luminaire for passage through and processing by the lens cells of the array.

8. A lens array system, comprising:
a liquid container enclosing an interior volume and having first and second windows formed of transparent material located to allow passage of light through the liquid container including through the interior volume;
first and second liquids, immiscible with respect to each other, together filling the interior volume of the liquid container, the first liquid being relatively insulating, and the second liquid being relatively conductive;
a grid wall inside the interior volume of the liquid container and extending from one of the windows at least partially across the interior volume toward the other of the windows, located so as to divide the interior volume of the liquid container into individual cells of a cellular electrowetting lens array, each electrowetting lens cell containing some of the first liquid and some of the second liquid;
a first electrode electrically connected to the grid wall; and
a second electrode configured to contact the conductive second liquid; and
a positive lens array mounted in proximity to one of the first and second windows of the cellular electrowetting lens array,
wherein:
the positive lens array modifies a focal point of light being transmitted through the one window, and
the electrodes are configured to receive a voltage for imparting a force to at least one of the liquids that changes the shape of the insulating liquid within each cell of the electrowetting lens array thereby modifying the focal point of light passing through the windows and the liquids in the cells of the electrowetting lens array.

9. The system of claim 8, wherein the grid wall is configured to divide the interior volume of the liquid container such that each individual electrowetting lens cell has a substantially square shape.

10. The system of claim 8, wherein individual lenses of the positive lens array are aligned with individual cells of the cellular electrowetting lens array.

11. The system of claim 10, wherein each individual lens of the positive lens array is one of a spherical lens or an aspherical lens.

12. The system of claim 8, wherein the positive lens array is mounted on the surface of the one window.

13. The system of claim 8, wherein the positive lens array is mounted a predetermined distance from the surface of the one window.

14. The system of claim 8, wherein the system is configured to be mounted to at least one of a residential or commercial light luminaire in a manner coupling light from a source within the luminaire for passage through and processing by the system.

15. A lens array system, comprising:
a liquid container enclosing an interior volume and having first and second windows formed of transparent material located to allow passage of light through the liquid container including through the interior volume;
first and second liquids, immiscible with respect to each other, together filling the interior volume of the liquid container, the first liquid being relatively insulating, and the second liquid being relatively conductive;
a grid wall inside the interior volume of the liquid container and extending from one of the windows at least partially across the interior volume toward the other of the windows, located so as to divide the interior volume of the liquid container into individual cells of a cellular electrowetting lens array, each electrowetting lens cell containing some of the first liquid and some of the second liquid;
a first electrode electrically connected to the grid wall; and
a second electrode configured to contact the conductive second liquid; and
a negative lens array mounted in proximity to one of the first and second windows of the cellular electrowetting lens array,
wherein:
the negative lens array modifies a focal point of light being transmitted through the one window, and
the electrodes are configured to receive a voltage for imparting a force to at least one of the liquids that changes the shape of the insulating liquid within each cell of the electrowetting lens array thereby modifying the focal point of light passing through the windows and the liquids in the cells of the electrowetting lens array.

16. The system of claim 15, wherein the grid wall is configured to divide the interior volume of the liquid container such that each individual electrowetting lens cell has a substantially square shape.

17. The system of claim 15, wherein individual lenses of the negative lens array are aligned with individual cells of the cellular electrowetting lens array.

18. The system of claim 17, wherein each individual lens of the negative lens array is one of a spherical lens or an aspherical lens.

19. The system of claim 15, wherein the negative lens array is mounted on the surface of the one window.

20. The system of claim 15, wherein the negative lens array is mounted a predetermined distance from the surface of the one window.

21. The system of claim 15, wherein the system is configured to be mounted to at least one of a residential or commercial light luminaire in a manner coupling light from a source within the luminaire for passage through and processing by the system.
